(19) United States
(12) Patent Application Publication
(10) Pub. No.: US 2006/0160606 A1
(43) Pub. Date: Jul. 20, 2006

(54) Method and system to provide a game feature

(76) Inventor: Gerald Duhamel, Drummondville (CA)

Correspondence Address: LABTRONIX CONCEPT INC.;C/O OGILVY RENAULT, 1981 MC GILL COLLEGE AVENUE, SUITE 1600, MONTREAL, QUEBEC, H3A 2Y3, CA

(21) Appl. No.: 11/358,064

(22) Filed: Feb. 22, 2006

Related U.S. Application Data
(63) Continuation-in-part of application No. 10/203,650, filed on Nov. 19, 2002.
(60) Provisional application No. 60/184,649, filed on Feb. 24, 2000.

(51) Int. Cl. A63F 13/00

(52) U.S. Cl. 463/20; 463/42

(57) ABSTRACT

In an embodiment, the invention provides a method of conducting a feature game along with a primary gaming process. The method comprises monitoring outcomes resulting from the conduct of the primary gaming process, wherein at least one of the primary-process outcomes comprises a feature modifying event. The method further comprises, upon detection of one the feature modifying event, applying a modification on feature data comprising a total feature point value and a feature target value, wherein one feature data modification may result in at least one state among (a) the total feature point value getting closer to the feature target value, (b) the total feature point value equaling the feature target value, and (c) the total feature point value falling beyond the feature target value, and wherein a feature winning state is obtained only when the total feature point value equals the feature target value. The method also comprises, upon occurrence of one feature winning state, providing a feature award.

### CROSS-REFERENCE TO RELATED APPLICATIONS

The present application is a Continuation-In-Part of U.S. application Ser. No. 10/203,650 filed Nov. 19, 2002, which is presently pending and which claims priority through International Patent Application no. PCT/CA01/00223 from Provisional Patent Application 60/184,649 filed Feb. 24, 2000, the specifications of which are hereby incorporated by reference.

### TECHNICAL FIELD

The invention relates to a method and system for providing a feature game.

### BACKGROUND OF THE INVENTION

The field of casino-style games and gaming machines is in constant evolution. Players are always demanding new characteristics or new applications of these characteristics that may incite them to play. While the variety of games has increased, players and game designers are still craving for novelty.

Accordingly, improvements in this field are desired.

### SUMMARY OF THE INVENTION

In an embodiment, the invention provides a method of conducting a feature game along with a primary gaming process. The method comprises monitoring outcomes resulting from the conduct of the primary gaming process, wherein at least one of the primary-process outcomes comprises a feature modifying event. It further comprises, upon detection of a feature modifying event, applying modification on feature data comprising a total feature point value and a feature target value, wherein a feature data modification results in at least one state among (a) the total feature point value getting closer to the feature target value, (b) the total feature point value equaling the feature target value, and (c) the total feature point value falling beyond the feature target value, and wherein a feature winning state is obtained when the total feature point value equals the feature target value. The method also comprises, upon occurrence of one said feature winning state, providing a feature award.

In another embodiment, the invention provides a feature control unit for controlling conduct of a feature game along with the conduct of a primary gaming process on a gaming machine. This primary gaming process involves primary-gaming outcomes. The feature control unit comprises storing means for storing feature data comprising a total feature point value and a feature target value; monitoring means for monitoring either one of primary-process outcomes or outcome signals representing said primary-process outcomes, wherein at least one of the primary-process outcomes comprises a feature modifying event; and modifying means for applying a modification on the feature data upon detection of one feature modifying event. Upon the feature data modification, the total feature point value may get closer to the feature target value, may equal the feature target value, or may go beyond the feature target value, wherein a feature winning state is obtained only when the total feature point value equals the feature target value. The feature control unit further comprises evaluating means for evaluating occurrence of one said feature winning state; and awarding means for signaling a feature award event upon occurrence of one said feature winning state.

In yet other embodiments, the invention provides a computer program embodied in an electric or electro-magnetic carrier signal or embodied on a computer-readable medium, the computer program having codes adapted to control the conduct of a feature game according to the present invention.

### BRIEF DESCRIPTION OF THE DRAWINGS

Further features and advantages of the present invention will become apparent from the following detailed description, taken in combination with the appended drawings, in which:

FIG. 1 is a schematic diagram showing a perspective view of a gaming machine suitable for the present invention;

FIG. 2 is a block diagram illustrating the components of the gaming machine of FIG. 1;

FIG. 3 is a flowchart illustrating the steps of a basic game process as played on the gaming machine of FIGS. 1 and 2;

FIG. 4 is a block diagram illustrating an embodiment of a feature control unit embodied within a network controller; and

FIG. 5 is a flow chart illustrating the steps involved in the conduct of one embodiment of the present feature game.

It will be noted that throughout the appended drawings, like features are identified by like reference numerals.

### DETAILED DESCRIPTION OF THE INVENTION

Lexicon

In this specification, the term “outcome” means “the result of a game process, which on its own or when compared with criteria, results in a useful value (such as a prize being either or not to be award)”. Examples of outcomes comprise the cards resulting from a poker game play; or one, some, or all of the game indicia displayed once the reels stop in a line game.

The terms “feature modifying event” mean “a triggering event resulting in a modification in the feature game”. Thus, any triggering event fulfilling a predetermined criterion and associated with a modification of the feature game would fulfill the definition of the feature modifying event.

The terms “feature award” means “something awarded to a player for his participation in the feature game”. According to embodiments, feature awards may take many forms, comprising monetary prizes, monetary prize modifiers, non-monetary prizes, and participations into features.

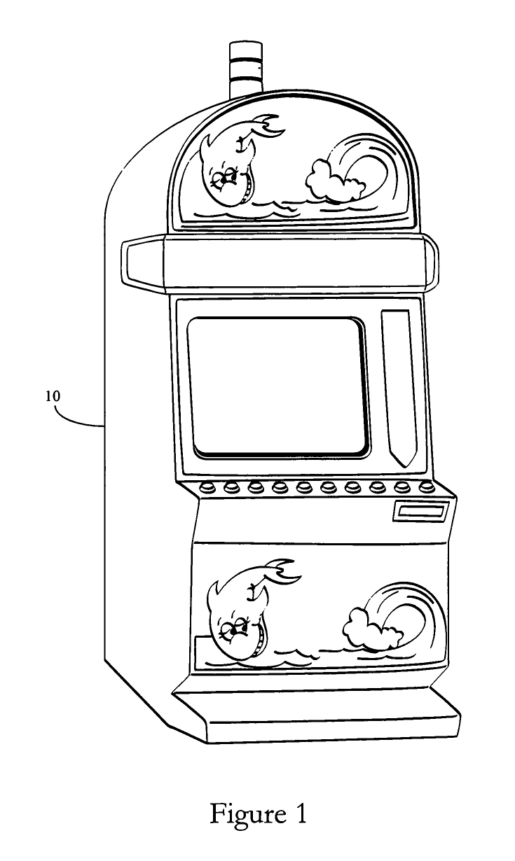

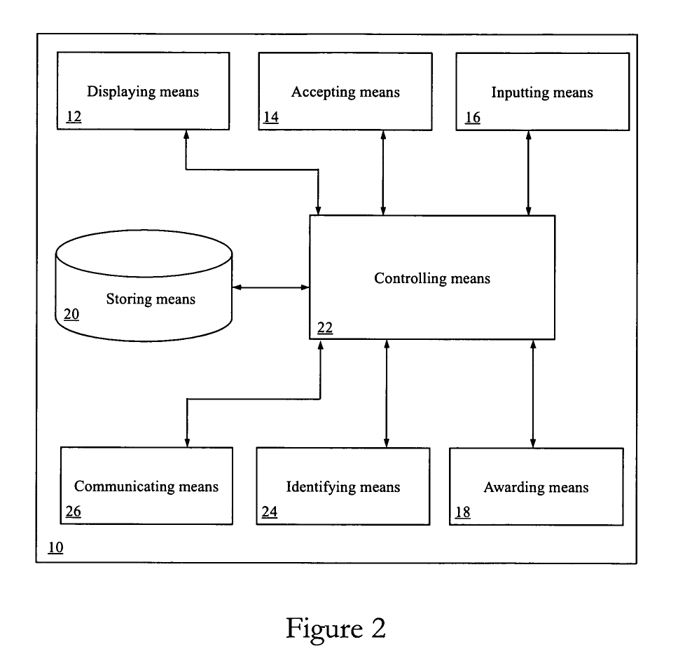

The present invention may be carried out on or in combination with a gaming machine, as illustrated on FIGS. 1 and 2. The gaming machine 10 comprises displaying means 12 such as a video screen a LCD screen, or mechanical reels; accepting means 14 such as a card reader or a coin and/or bill acceptor; inputting means 16 such as buttons, levers or a touch screen; awarding means 18 such as a ticket printer, a card reader or a hopper; storing means 20 such as RAM, flash memory, a hard drive or a removable memory medium; and controlling means 22, such as a computer, computer codes, or a hardware controller. The gaming machine 10 may further comprises, depending on the embodiments, identifying means 24, such as a smart card, or a player recognition system; and communicating means 26, such as a communication port, or a wireless communication system.

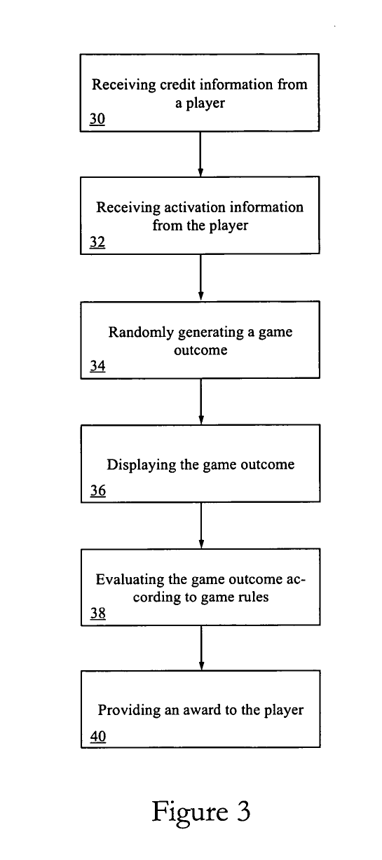

The gaming machine 10 is designed, in its basic realization and as shown on FIG. 3, to conduct a wagering game. The conduct of one such wagering game involves to receive credit information from a player (step 30) either in a physical format (such as coins or bills) or in an electronic format (such as a player card or a money transfer from a bank account), to receive activation information from the player (step 32), to randomly generate (step 34) and display (step 36) a game outcome, to evaluate said game outcome according to game rules (a pay schedule for example) (step 38), and to award a prize to the player for a winning game outcome (step 40).

According to one embodiment, the gaming machine 10 is adapted to conduct the feature game of the present invention along with the primary game, or another process conducted on gaming machine 10. When gaming machine 10 is adapted to conduct the feature game, storing means 20 is adapted to store information regarding the conduct of the feature game; controlling means 22 is adapted to conduct the feature game; and awarding means 18 is adapted to provide a feature prize upon detection of a feature winning state.

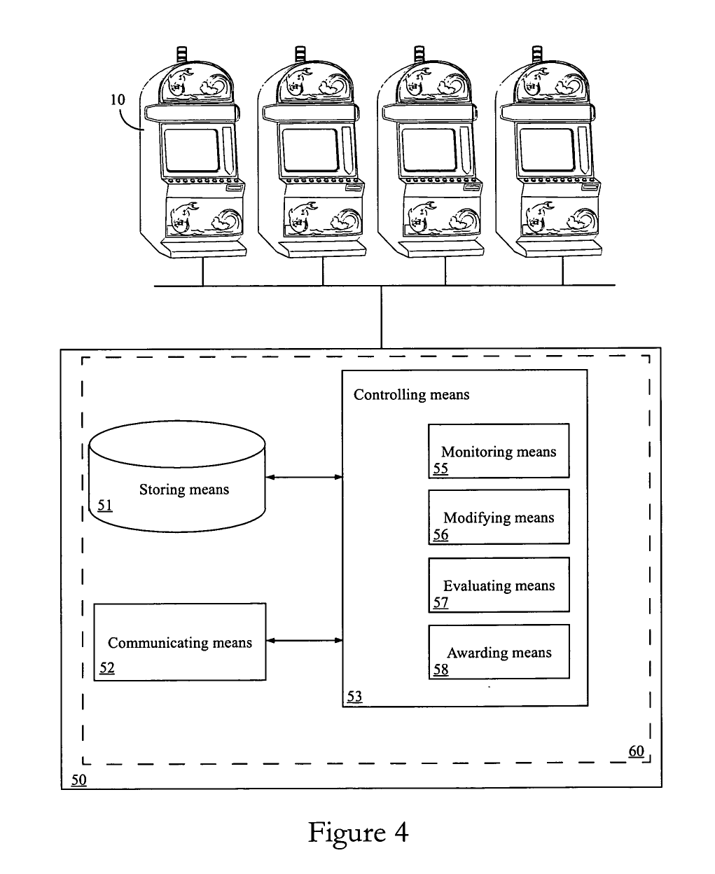

According to another embodiment, the gaming machine 10 is adapted to conduct the wagering game (being or including the primary gaming process) and to communicate signals influencing the conduct of the feature game to a feature control unit 60, either comprised in a network controller 50 communicatively linked to the gaming machine 10 or in the gaming machine 10. According to the networked realization of the present embodiment as illustrated on FIG. 4, the feature control unit 60 of the network controller 50 comprises storing means 51, such as RAM, flash memory, a hard drive or a removable memory medium; controlling means 53 such as a computer, computer codes, or a hardware controller. The controlling means 53 may include: monitoring means 55 monitoring feature modifying events, modifying means 56 applying modification of feature data, evaluating means 57 evaluating occurrence of feature winning states, and awarding means 58 signaling winning state occurrences. Alternatively, the foregoing controlling means components may be separate from the controlling means. The present feature control unit 60 further comprises communicating means 58, such as a communication port, or a wireless communication system. The feature control unit 60 is adapted to conduct the feature game of the present invention based on signals received from the gaming machines 10, including signaling one of the gaming machines 10 to provide a feature prize when appropriate.

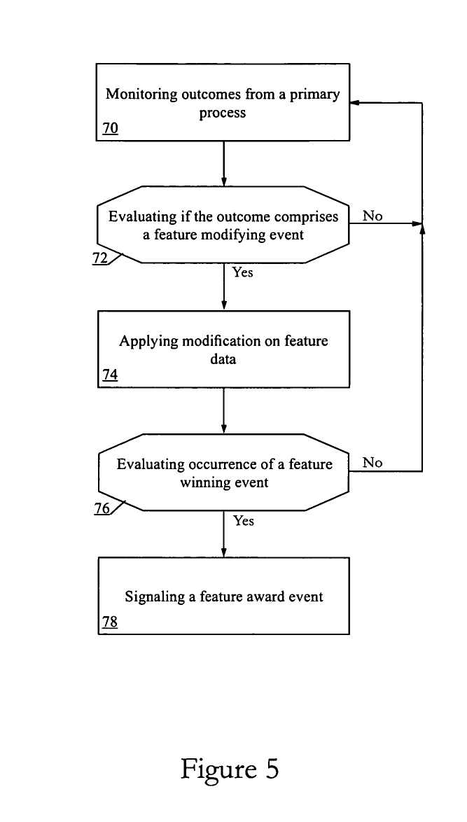

According to an embodiment wherein the feature game is applied on a gaming machine 10, the method may be described, as shown on the flow chart of FIG. 5. The method includes monitoring outcomes as they are generated in a primary gaming process (step 70), for example a primary game; evaluating if the outcome comprises a feature modifying event (step 72); and, in negative, continuing monitoring further outcomes (step 70). However, when the monitored outcome comprises a feature modifying event, applying a modification on the feature data (step 74); evaluating if a winning state has occurred (step 76), and either signaling a feature award event (step 78), or continuing monitoring outcomes (step 70).

According to other embodiments, further steps may take place in the conduct of the feature game of the present invention. These variations will become apparent from the following detailed descriptions of different embodiments of the feature game of the present invention.

According to one embodiment disclosed in U.S. application Ser. No. 10/203,650 filed Nov. 19, 2002, entitled “Jackpot Awarding System”, and incorporated herein by reference, the feature game of the present invention is conducted during the play of a poker game (i.e., the primary game or primary gaming process). As the player gets poker outcomes is the game, these outcomes are evaluated to determine a poker prize to award to the player. Furthermore, when a poker outcome fulfills a predetermined criterion (a hand ranking at least as a pair of Jacks), a number of points reflecting the participation of the player in the feature game is incremented. When the current number of points accumulated (hereinafter also called a total feature point value) equals a goal point value (hereinafter called a feature target value), the player is awarded a jackpot amount.

According to the embodiments disclosed in U.S. application Ser. No. 10/203,650, the game played in order to gather points, the parameters influencing the point gathering process and the number of points awarded for a particular outcome may vary. Furthermore, the following embodiments are hereinafter described in order to allow the reader to obtain a better understanding of the breadth of the possible embodiments according to the present feature game.

According to one embodiment, a poker game is played on a gaming machine with a total feature point value and a feature target value being maintained by the gaming machine as the poker game is conducted. When a poker outcome fulfills a predetermined point-gathering criterion (e.g., ranking over a three-of-a-kind), the total feature point value is modified according to the value of the card duplicated at least three times multiplied by the number of credits wagered by the player. For example, upon occurrence of a four-of-a-kind ranking hand comprising four 5's with the player having wagered 7 credits, the total feature point value is increased of 35 points.

In the same embodiment, upon occurrence of a pushing-away criterion (e.g., a losing hand comprising a particular card such as a joker), the feature target value is modified to increase the distance between the total feature point value and the feature target value. In the present embodiment, the feature target value is increased by a number of points corresponding to the sum of the cards composing the losing hand multiplied by the wager value in credits.

In one embodiment, when the total feature point value equals the feature target value, the player is awarded the winning value of the feature game. In another embodiment, when such a feature winning state occurs, the player is provided a special feature such as a participation in a bonus feature. In another embodiment, the occurrence of such a feature winning state results in the value of the last win being multiplied by a feature multiplier. In another embodiment, the occurrence of a feature winning state results in the player being awarded a gift or a predetermined non-monetary prize.

According to another embodiment, when the feature winning state does not occur, but a predetermined criterion is fulfilled, the player is provided with an award differing from the feature award. In the present embodiment, if the player does exceed the feature target value with a four-of-a-kind hand, he is awarded a non-winning feature award: a number of free plays corresponding to the four-of-a-kind hand ranking (e.g., 10 free spins for a four-of-a-kind of 10's).

Therefore, depending on the chosen embodiments, many ways are available to provide the player with a feature award upon occurrence of a feature winning state.

In another embodiment, the game played is a line game. In the embodiment, each time a point indicium (in this particular example, a symbol representing a dart target) takes part in the outcome, the total point value increases according to the number of times this point indicium appears. When a reset indicium (a symbol representing a “Game End” sign over a dart target) appears in the outcome, or when the total feature point value exceeds the feature target value, the total feature point value resets to an initial value (0). Upon the total feature point value being equal to the feature target value, the player accesses a bonus feature.

In another embodiment, the player may select which indicia influence the conduct of the feature game, with the occurrence probability, or value, of these indicia being modified depending on the selected indicia

In another embodiment, the feature game is conducted on a networked feature control unit in communication with a plurality of gaming machines. Each gaming machine maintains its own total feature point value evolving according to the outcomes occurring on the gaming machine. Furthermore, the gaming machines communicate changes in their total feature point value as they occur. The feature control unit, embodied in the network controller, monitors the evolution of the total feature point values on the gaming machines, and signals a gaming machine to award a feature prize when the total feature point value on that gaming machine equals the feature target value. However, if the total point value of a gaming machine exceeds the feature target value, either the total point feature value of the gaming machine or of all gaming machines is modified. The first player who has his total feature point value equaling the feature target value wins the feature prize: a progressive prize in this particular example.

In another embodiment, upon occurrence of a triggering event in a primary game, a bonus feature (a.k.a. a feature game) begins. In the bonus feature, the player is provided with a plurality of objects each having a concealed value. The player is also provided with a target value and a number of picks. Each time the player uses one of his picks (thus each time the player acts on the game, or applies a control), he selects an object (in other words, an object selection by the player), the object value (an outcome) is revealed, and a bonus meter is increased according to the value revealed. According to one embodiment, when the bonus meter value matches the target value following the use of one of the picks, the player is provided with an additional award (for example, a premium or an extra number of picks). According to another embodiment, this additional award is provided only if the match occurs when the player uses his last pick.

In other embodiment, as disclosed in U.S. application Ser. No. 10/203,650, the action the player applies that may modify the conduct of the feature game may comprise a selection of cards, or a selection of a bet level (with the feature point value to add to the total feature point value depending on the bet level applied). In another embodiment, a configuration selection may influence the game feature. For example, the player may perform a bonus feature selection among a plurality of bonus features, with the selection influencing the way the feature point values are awarded to the player or the feature target value.

According to the embodiments, feature data may be provided to the player under different forms, with these forms providing the feature data and the evolution of the feature data in a comprehensive way to the player. In one embodiment, the total feature point values and the feature target values are provided as numbers. In another embodiment, these values are provided as thermometer levels (i.e. locations relative to the thermometer scale) with equal values being illustrated as a single color (e.g., the total feature point value being blue, the feature target value being yellow, and the overlapping of the two values being green). In another embodiment, the feature game is illustrates as horses (i.e. objects), or a horse (i.e. an object) and a finishing line (i.e. a location the object reaching), in a race simulation.

According to an embodiment, a player tracking system permits to a player to store feature data between play sessions. Therefore, for example through player identification means, feature data associated with a player identification may be retrieved when beginning a play session for the player to participate in the feature game according to the state he was in at the end of his last play session.

According to an embodiment, the feature data may depend on the game being played, with the feature data being re-initialized each time a new play session begins in that game. In another embodiment, the feature data are independent from the game played. However, the event resulting in modification of feature data and these modifications may change from one game to another.

It will be noted that the above embodiments illustrate different characteristics the present invention may present. Those skilled in the art will recognize that, even if the above embodiments describe these characteristics as part of different embodiments, one could combine some of these characteristics. Furthermore, the invention may also present other characteristics and/or variations, with such characteristics falling within the scope of the invention, as set forth in the appended claims.

While the appended block diagrams illustrate the present invention as groups of discrete components communicating with each other via distinct data signal connections, it will be understood by those skilled in the art that the invention may be embodied through a combination of hardware and software components, with some components being implemented by a given function or operation of a hardware or software system, and many of the data paths illustrated being implemented by data communication within a computer application or operating system. The structure illustrated is thus provided for efficiency of teaching embodiments of the invention.

It should be noted that the present invention can be carried out, as above described, as a method or embodied in a machine or a system. However, it may also be carried out as a computer readable medium, a processing-readable memory, or an electrical or electro-magnetic signal.

Thereupon, it is the intent to efficiently teach the invention through exemplary embodiments, while solely the scope of the appended claims is intended to limit the scope of the invention.

I/We claim:

1. A method of conducting a feature game along with the conduct of a primary gaming process, the method comprising:
monitoring outcomes resulting from the conduct of the primary gaming process, wherein at least one of the primary-process outcomes comprises a feature modifying event;
upon detection of said feature modifying event, applying a modification on feature data comprising a total feature point value and a feature target value, wherein said feature data modification may result in at least one state among (a) the total feature point value gets closer to the feature target value, (b) the total feature point value equals the feature target value, and (c) the total feature point value goes beyond the feature target value, and wherein state (b) is a feature winning state while states (a) and (c) are not feature winning states; and
upon occurrence of said feature winning state, providing a feature award.

2. The method of claim 1, wherein a plurality of said feature modifying events are necessary for a feature winning state to occur.

3. The method of claim 1, wherein said feature data modification may result in a further state wherein the total feature point value gets farther from the feature target value.

4. The method of claim 1, wherein primary gaming process comprises at least one of a wagering game and a bonus feature resulting from the occurrence of a triggering event in a wagering game.

5. The method of claim 1, further comprising modifying said feature data upon occurrence of a non-winning state fulfilling a predetermined criterion.

6. The method of claim 1, further comprising illustrating said feature data in a comprehensive way to a player.

7. The method of claim 6, wherein the comprehensive way comprises at least one of: a representation of the total feature point value and the feature target value; and locations or objects representing the total feature point value and the feature target value.

8. The method of claim 1, wherein the primary gaming process is influenced by an action from a player for its completion.

9. The method of claim 8, wherein said player action comprises at least one of an object selection, a bet level selection, and a configuration selection.

10. The method of claim 1, further comprising signaling a second prize event upon occurrence of a feature state fulfilling a predetermined criterion while not being a feature winning state.

11. The method of claim 1, wherein said feature data modification comprises an incrementing of the total feature point value by a non-unitary value.

12. The method of claim 1, wherein said feature award is a progressive prize.

13. The method of claim 1, wherein said feature award comprises at least one of a non-monetary award; and a feature participation potentially generating a monetary or non-monetary award.

14. The method of claim 1, wherein the feature data is associated with a player identification.

15. The method of claim 1, wherein the feature data is associated with said primary gaming process.

16. A feature control unit for controlling the conduct of a feature game along with the conduct of a primary gaming process on a gaming machine, wherein the primary gaming process involves primary-process outcomes, the feature control unit comprising:
storing means for storing feature data comprising a total feature point value and a feature target value;
monitoring means for monitoring either one of primary-process outcomes or outcome signals representing said primary-process outcomes, wherein at least one of the primary-process outcomes comprises a feature modifying event;
modifying means for applying a modification on the feature data upon detection of one said feature modifying event, wherein one said feature data modification may result in at least one states among (a) the total feature point value getting closer to the feature target value, (b) the total feature point value equaling the feature target value, and (c) the total feature point value going beyond the feature target value, and wherein a feature winning state is obtained only when the total feature point value equals the feature target value;
evaluating means for evaluating occurrence of one said feature winning state; and
awarding means for signaling a feature award event upon occurrence of one said feature winning state.

17. The feature control unit of claim 16, wherein said feature control unit is embodied in one of said gaming machine or a network controller.

18. The feature control unit of claim 16, wherein said feature control unit is communicating with one of an outcome-providing device providing said primary-process outcomes and said gaming machine, said feature control unit communicating through a communicating means.

19. The feature control unit of claim 16, wherein said storing means maintains the featured data over a plurality of primary-process outcomes.

20. The feature control unit of claim 16, further comprising an identifying means permitting to associate the feature data with a player identification.

21. A computer program embodied in an electric or an electro-magnetic carrier signal having codes adapted, when performed by processing means:
to maintain feature data comprising a total feature point value and a feature target value;
to perform monitoring of one of primary-process outcomes or outcome signals representing said primary-process outcomes, wherein at least one of said primary-process outcomes comprises a feature modifying event;
to apply a modification on the feature data upon detection of one said feature modifying event, wherein one said feature data modification may result in at least one state among of (a) the total feature point value getting closer to the feature target value, (b) the total feature point value equaling the feature target value, and (c) the total feature point value going beyond the feature target value, and wherein a feature winning state is obtained only when the total feature point value equals the feature target value;
to evaluate occurrence of one said feature winning state; and
to signal a feature award event upon occurrence of one said feature winning state.

22. A computer program embodied on a computer readable medium or processor-readable memory having codes adapted, when performed by processing means:
to maintain feature data comprising a total feature point value and a feature target value;
to perform monitoring of one of primary-process outcomes or outcome signals representing said primary-process outcomes, wherein at least one of said primary-process outcomes comprises a feature modifying event;
to apply a modification on the feature data upon detection of one said feature modifying event, wherein one said feature data modification may result in at least one state among (a) the total feature point value getting closer to the feature target value, (b) the total feature point value equaling the feature target value, and (c) the total feature point value going beyond the feature target value, and wherein a feature winning state is obtained only when the total feature point value equals the feature target value;
to evaluate occurrence of one said feature winning state; and
to signal a feature award event upon occurrence of one said feature winning state.
